(19) United States
(12) Patent Application Publication
(10) Pub. No.: US 2024/0182188 A1
(43) Pub. Date: Jun. 6, 2024

(54) Magnetic Flux Engine for Spacecraft Propulsion

(71) Applicant: Overawe, LLC, Alice, TX (US)

(72) Inventor: Encarnacion Gonzalez, Alice, TX (US)

(73) Assignee: Overawe, LLC, Alice, TX (US)

(21) Appl. No.: 18/441,934

(22) Filed: Feb. 14, 2024

Related U.S. Application Data
(62) Division of application No. 18/097,312, filed on Jan. 16, 2023.
Application No. 18/097,312 is a continuation-in-part of application No. 16/912,801, filed on Jun. 26, 2020, now abandoned.
(60) Provisional application No. 62/872,115, filed on Jul. 9, 2019.

(51) Int. Cl. B64G 1/40; F03H 1/00; H01F 6/00; H01F 7/20; H02K 53/00; H02K 99/00

(52) U.S. Cl. CPC B64G 1/409; F03H 1/0081; H01F 6/00; H01F 7/202; H02K 53/00; H02K 99/20

(57) ABSTRACT

As is scientifically well known, magnetic flux is a physical force (i.e. the Lorentz force and Ampere's force). The invention utilizes a plurality of electromagnetic and or plasma coils to create high pressure, high velocity magnetic flux directed through variable exhaust nozzles or a cone shaped electrical coil to create thrust for spacecraft. Electrically charged ions or electrons are collected and propelled along the created magnetic flux lines through the variable exhaust nozzles or electrical coils to create thrust.

### CROSS-REFERENCE TO RELATED APPLICATIONS

This application takes benefit of U.S. Prov. Pat. App. No. 62/872,115 filed Jul. 9, 2019, U.S. patent application Ser. No. 16/912,801 filed Jun. 26, 2020, and is, because of a restriction requirement, a divisional of U.S. Continuation-in-Part patent application Ser. No. 18/097,312 filed Jan. 16, 2023, all of which are included, in their entirety, by reference.

### FIELD OF THE INVENTION

This invention relates to spacecraft propulsion. As is scientifically well known, magnetic flux is a physical force (i.e. the Lorentz force and Ampere's force). This invention utilizes a plurality of electromagnetic and or plasma coils to create high pressure, high velocity magnetic flux directed through variable exhaust nozzles or a cone shaped coil to create thrust for spacecraft. Depending on the polarity of electricity supplied to the invention, ambient electrons or ions are collected and magnetically accelerated though the invention, creating thrust.

### BACKGROUND OF THE INVENTION

For many years extensive research has been done by private and government entities directed towards creating practical long-term infinite distance propulsion systems for spacecraft. Electromagnetic flux exists throughout the known universe. Accordingly, a spacecraft propulsion system that utilizes electromagnetic flux by directing magnetic flux in a specific direction is desirable.

### SUMMARY OF THE INVENTION

The present invention relates to spacecraft propulsion systems which utilize magnetic flux as a physical force to propel spacecraft through the vacuum of outer space. The system uses a plurality of coils of electrically conductive material, super conducting material, or plasma coils designed to create high density, high magnetic flux pressure, high velocity electromagnetic flux fields routed through a variable exhaust nozzle or a cone shaped coil to create thrust.

The system may initially be powered by banks of capacitors or super capacitors. The magnetic fields initially produced will interact with a plurality of coils designed to create electric power for the system. Solar power, a nuclear reactor, a fusion reactor, or batteries may optionally power the system.

This invention utilizes a plurality of electromagnetic and or plasma coils to produce high pressure, high velocity magnetic flux (Lorentz force, Ampere force) to create thrust for spacecraft. Thrust is created by magnetically attracting and unidirectionally propelling charged ionic matter located generally at the input of the invention along the generated magnetic field lines creating a volumetric coefficient of expansion which will be condensed and/or concentrated as the charged ionic matter travels through, and, out the output of the invention.

### BRIEF DESCRIPTION OF THE DRAWINGS

FIG. 1 shows a side cutaway view of a magnetic flux engine 99 for spacecraft propulsion.

FIG. 2 shows a detailed side cutaway view of a magnetic flux engine 99 with flux pressure controllers 105 at both ends.

FIG. 3 shows a diagonal view of the optional two separate halves of the inner central conduit 103 with retainer rings 110 and a single flux pressure controller 105.

FIG. 4a shows a diagonal view of inner central conduit 203 with two formed, unwound pressure controllers 210 and 220 affixed.

FIG. 4b shows a detailed side cutaway view of inner central conduit 203 with two formed, wound pressure controllers 210 and 220 affixed.

FIG. 5 shows a detailed side cutaway view of inner central conduit 303 with two formed, wound pressure controllers 310 and 320 affixed.

FIG. 6a shows a detailed side cutaway view of two formed, wound pressure controllers 410 and 420 wherein one is concentrically enclosed in the other.

FIG. 6b shows a detailed side cutaway view of an alternative embodiment using a single formed, wound pressure controller 420.

FIG. 7 shows a longitudinal section of an embodiment of the nacelle/pod 501 mounted in a pod that rotates 360°.

FIG. 8a shows a cross-section of the drive elements of an embodiment of the nacelle/pod 501 pictured in FIG. 7.

FIG. 8b shows a detail of a portion of the tip of a rotor 507 as it passes by a large stator element 504 in an embodiment of the present invention. A large stator element 504 presents a less focused, less directed beam of electromagnetic energy to the rotor 507 as it passes by.

FIG. 8c shows a detail of a portion of the tip of a rotor 507 as it passes by a small stator element 504a in an embodiment of the present invention. A small stator element 504a presents a more focused, more directed beam of electromagnetic energy to the rotor 507 as it passes by.

FIG. 9 shows a cross-sectional view of the detail of a portion of the tip of a rotor 507 as it passes by a large stator element 504 in an alternative embodiment of the present invention. The rotor 507 is supported and guided by two peripheral electromagnetic guides 509a and 509b running in two concentric guide channels 507c and 507d.

FIG. 10 shows a cross-sectional view of the detail of a rotor 507 configured between large stators 504 on opposite sides of the stator ring in an alternative embodiment of the present invention. The rotor 507 is supported and guided by two peripheral electromagnetic guides 509a and 509c running in two concentric guide channels 507c and 507d. The two peripheral electromagnetic guides 509a and 509c are different in cross-section as shown.

FIG. 11 shows a cross-sectional view of the detail of a portion of the tip of a rotor 507 as it passes by a large stator element 504 in an alternative embodiment of the present invention. The rotor 507 is supported and guided by two peripheral electromagnetic guides 509a and 509c running in two concentric guide channels 507c and 507d. The two peripheral electromagnetic guides 509a and 509c are different in cross-section as shown. A solenoid controlled braking and stabilizing system is shown in components 510 through 514. As shown in FIG. 10, inside of rotor 507 is integral auger type blade 516.

FIG. 12 shows a cross-section of the drive elements of an embodiment of the present invention pictured in FIG. 11. Peripheral electromagnetic guide 509c is show constructed in two halves of concentrically wound wire (as 509a is FIG. 11) showing that the form of both of the peripheral electromagnetic guides (509a and 509c) may be different (as shown in FIG. 11) or the same (as shown in FIG. 9).

FIG. 13 shows a diagonal view of integral auger type blade 516 affixed inside a rotor.

### DETAILED DESCRIPTION OF THE INVENTION

The invention is not limited to the embodiments shown which only represent examples of the current invention.

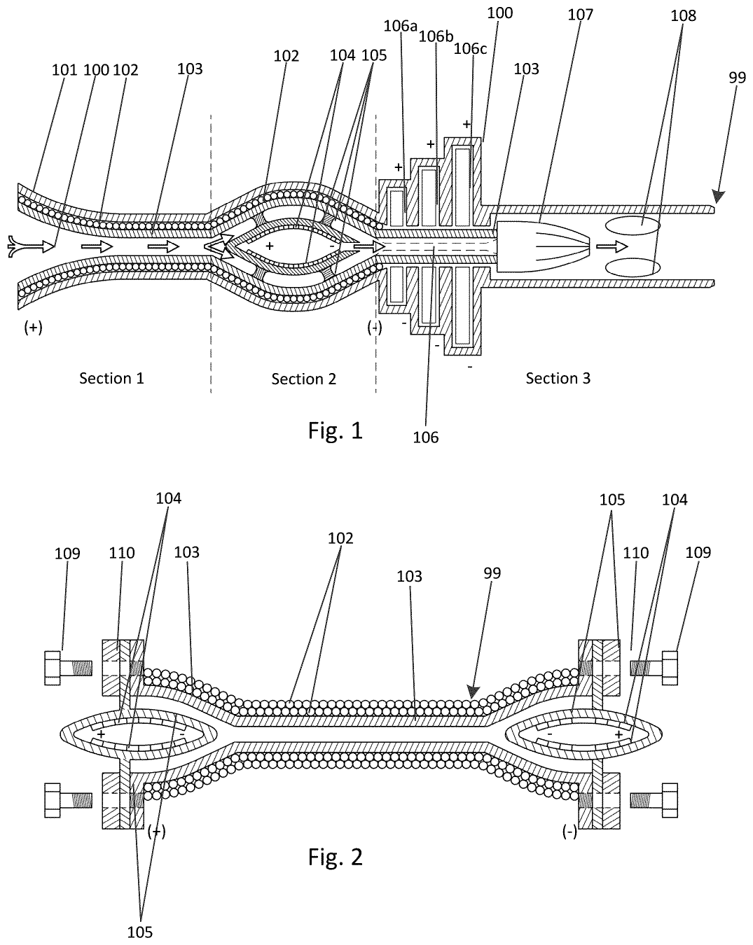

FIG. 1 shows a side cross-sectional cutaway view of a magnetic flux engine 99 for spacecraft propulsion. The system uses a plurality of coils of electrically conductive material 102 and 104, super conducting material, or plasma coils designed to create high density, high magnetic flux pressure 100, high velocity electromagnetic flux fields routed through a variable exhaust nozzle 107 or a cone shaped coil to create thrust. The present invention shows a plurality of different layered materials 101, 102, 103, 104, and 105. Inner central conduit 103 may be constructed of high permeability magnetic material. Inner central conduit 103 also shows a flux pressure controller 105 with an inner electric coil 104 that may be used to create a controllable counter magnetic field to create magnetic flux pressure. Also shown are venturi acceleration coils 106a, 106b, and 106c, variable exhaust nozzle 107 or a cone shaped coil, and a plurality of electric power coils 108 that will interact with magnetic flux 100 designed to produce electric power. Also shown is a layer of electrical conductors 102 and or super conductors, that, when energized will create and/or draw in high density, high velocity magnetic flux 100, through inner central conduit 103, through high velocity venturi 106 and its associated venturi acceleration coils 106a, 106b, and 106c, and through variable exhaust nozzle 107 or a cone shaped electrical coil constructed of non-ferrous magnetic material designed to deflect and/or create high pressure, high velocity magnetic flux thrust. Those having skill in the art will recognize that embodiments of the invention may be constructed with multiple layers of electrical conductors 102 and or super conductors. Also shown is outer layer 101 constructed of non-ferrous magnetic material designed to contain high velocity magnetic flux 100 and prevent magnetic flux leakage.

Outer space (or simply space) is the expanse beyond celestial bodies and their atmospheres. Outer space is not completely empty; it is a near perfect vacuum containing a low density of particles, predominantly a plasma of positively charged hydrogen and helium ions and negatively charged electrons. FIG. 1 shows a positive (“+”) charge on the input (Section 1) but those having skill in the art will recognize that by changing the polarity of the electrical power supplied to the magnetic flux engine 99, the input (Section 1) may have a negative (“−”) charge.

When positively charged, the magnetic flux engine 99 attracts negatively charged particles (primarily electrons) to the input (Section 1) and when negatively charged, the magnetic flux engine 99 attracts positively charged particles (primarily hydrogen and helium ions) to the input (Section 1). These electrons or ions are accelerated through the magnetic flux engine 99 by the high velocity magnetic flux 100 from Section 1, through Section 2, and out of Section 3.

This stream of accelerated electrons or ions creates thrust directed along the magnetic field lines created by the high velocity magnetic flux 100 as it proceeds from Section 1, through Section 2, and out of Section 3. One having skill in the art will recognize that electrons or ions may be captured from any direction relative to the input (Section 1), but that those electrons or ions are directed linearly along the magnetic field lines through the output of the magnetic flux engine 99 (Section 3).

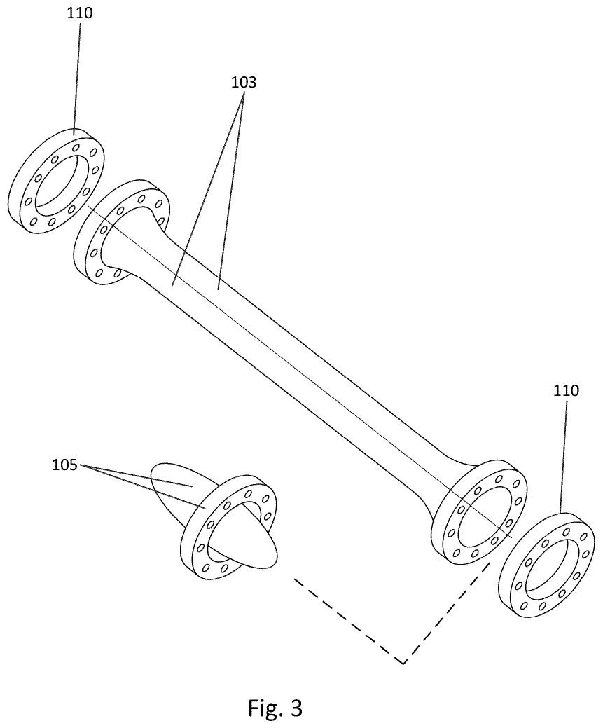

Referring now to FIG. 2, the diagrams show a side cutaway view of an alternative embodiment of a magnetic flux engine 99. The present invention is designed to create high pressure, high velocity magnetic flux for spacecraft propulsion. Inner central conduit 103 is constructed of high and/or ultrahigh permeability magnetic material including, but not limited to, iron based composite nanocrystalline foil, or nickel-plated neodymium composites. Inner central conduit 103 is wrapped with multiple layers of electrical conductors 102 and or super conductors such that when energized creates and/or draws in high density, high pressure, high velocity magnetic flux through the inner central conduit 103 in either direction depending on the polarity of electric power applied to electrical conductors 102. Also shown are flux pressure controllers 105 located at both ends with inner electric coils 104 to create counter electric fields to create controllable magnetic flux pressure and velocities. Optionally, inner central conduit 103 may be constructed of separate portions and joined together by outer retainer rings 110 located at both ends. As discussed above, electrons or ions may be captured from any direction relative to the input (the left end) of the magnetic flux engine 99 and those electrons or ions are directed linearly along the magnetic field lines and expelled through the output (the right end) of the magnetic flux engine 99.

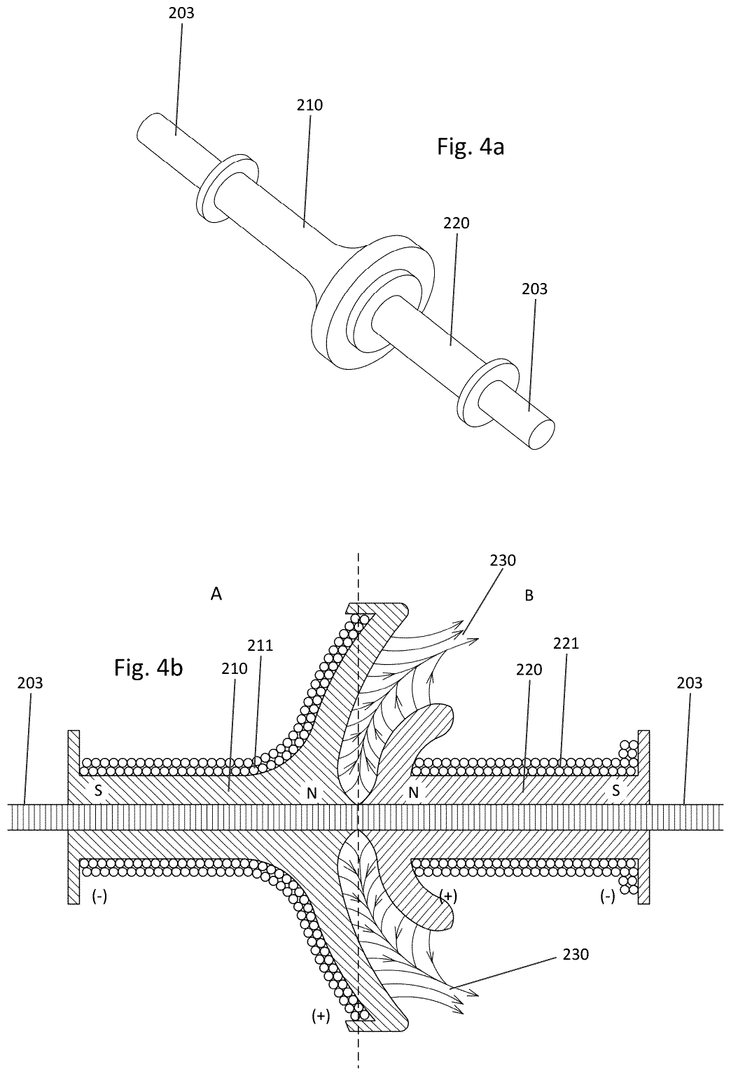

Referring now to FIG. 3, the diagram shows a partially disassembled diagonal view of the optional two separate halves of the inner central conduit 103 with retainer rings 110 and a flux pressure controller 105. Note that the inner central conduit 103 may be manufactured monolithically or in two or more pieces.

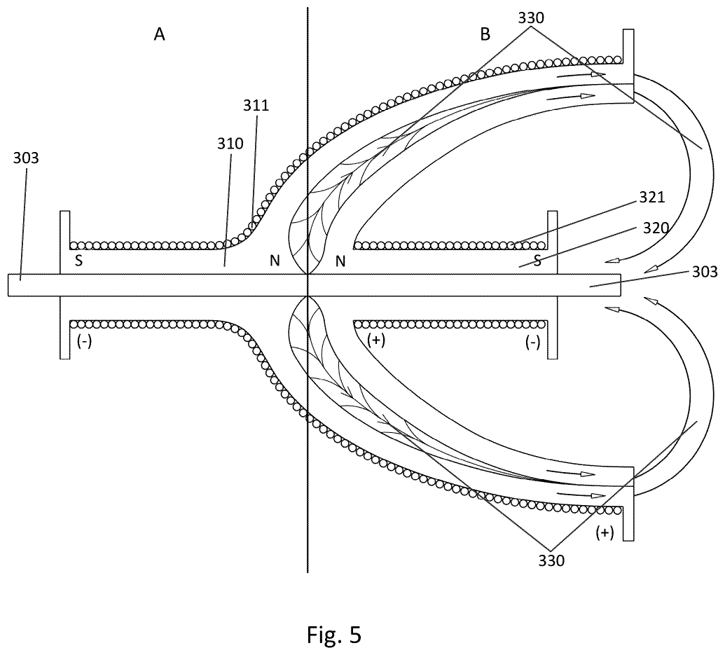

Referring now to FIG. 4a, the diagram shows inner central conduit 203 with two formed, unwound pressure controllers 210 and 220 affixed. Note that inner central conduit may be threaded so that pressure controllers 210 and 220 may be placed at different locations with respect to one another on inner central conduit 203.

Referring now to FIG. 4b, the diagram shows a side cutaway view of inner central conduit 203 with two formed, wound pressure controllers 210 and 220 affixed. Inner central conduit 203 may be threaded so that pressure controllers 210 and 220 may be placed at different locations with respect to one another on inner central conduit 203. Alternately, pressure controllers 210 and 220, may be electrically, electromechanically, or hydraulically configured to be placed at different locations with respect to one another on inner central conduit 203. Inner center conduit 203 may be constructed of high permeability magnetic material. Inner central conduit 203 also shows formed, wound pressure controllers 210 and 220 wrapped with multiple layers of electrical conductors 211 and 221 and or super conductors, respectively. Formed, wound pressure controllers 210 and 220 are juxtaposed next to each other on inner central conduit 203 such that when simultaneously energized the electromagnetic flux 230 created by their north (N) poles is directed towards one another. Since wound pressure controller 210 is physically larger than wound pressure controller 220, the combined electromagnetic flux 230 is directed rearward (to the right) of wound pressure controller 220. This creates a minute thrust of the entire assembly forward (to the left). The amount of thrust is proportional to the current applied to the electrical conductors 211 and 221 and or super conductors. The amount of thrust may also be controlled by changing the horizontal distance between pressure controllers 210 and 220 on inner central conduit 203.

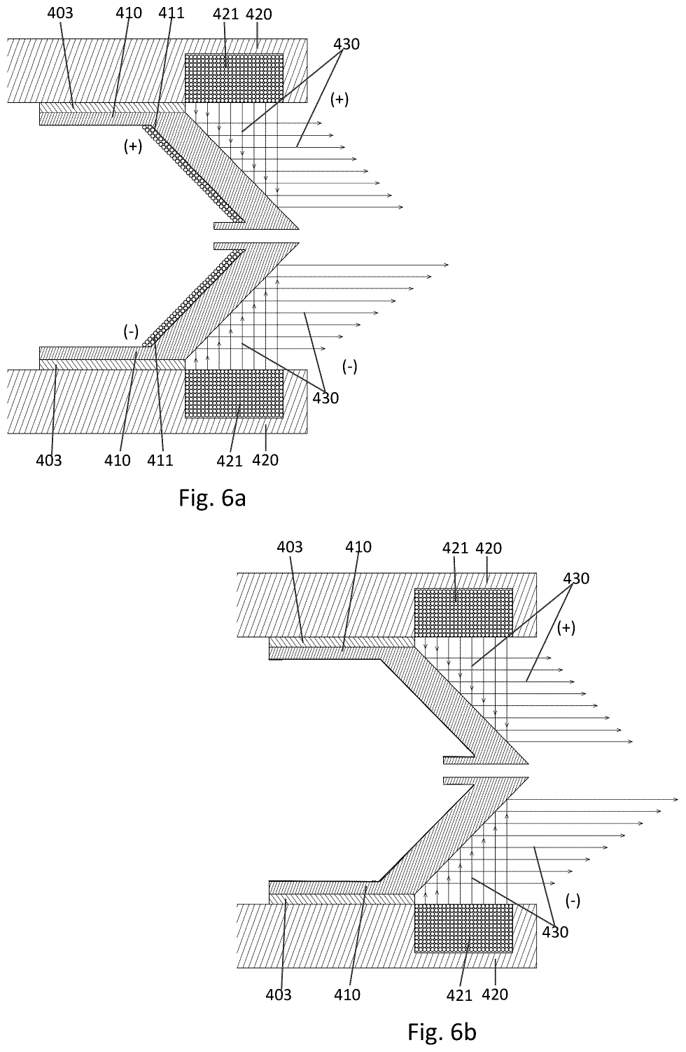

Referring now to FIG. 5, the diagram shows a side cutaway view of inner central conduit 303 with two formed, wound pressure controllers 310 and 320 affixed. Inner central conduit 303 may be threaded so that pressure controllers 310 and 320 may be placed at different locations with respect to one another on inner central conduit 303. Alternately, pressure controllers 310 and 320, may be electrically, electromechanically, or hydraulically configured to be placed at different locations with respect to one another on inner central conduit 303. Inner central conduit 303 may be constructed of high permeability magnetic material. Inner central conduit 303 also shows formed, wound pressure controllers 310 and 320 wrapped with a single layer of electrical conductors 311 and 321 and or super conductors, respectively. Those having skill in the art will recognize that formed, wound pressure controllers 310 and 320 may be wrapped with multiple layers of electrical conductors 311 and 321 and or super conductors, respectively. Formed, wound pressure controllers 310 and 320 are juxtaposed next to each other on inner central conduit 303 such that when simultaneously energized the electromagnetic flux 330 created by their north (N) poles is directed towards one another. Since wound pressure controller 310 is physically larger than wound pressure controller 320, the combined electromagnetic flux 330 is directed rearward (to the right) of wound pressure controller 320. This creates a minute thrust of the entire assembly forward (to the left). The amount of thrust is proportional to the current applied to the electrical conductors 311 and 321 and or super conductors. The amount of thrust may also be controlled by changing the horizontal distance between pressure controllers 310 and 320 on inner central conduit 303.

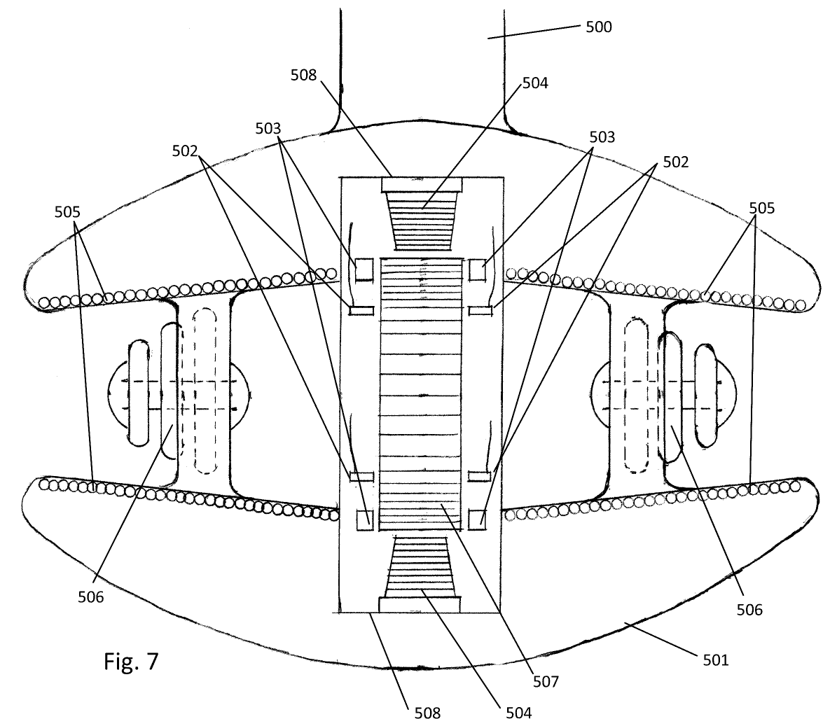

Referring now to FIG. 6a, the diagram shows a side cutaway view of cylindrical peripheral conduit 403 with two cylindrical formed, wound pressure controllers 410 and 420 affixed. Cylindrical peripheral conduit 403 may be threaded on its inside and/or outside surfaces so that cylindrical pressure controllers 410 and 420 may be placed at different locations with respect to one another on cylindrical peripheral conduit 403. Alternately, cylindrical pressure controllers 410 and 420, may be electrically, electromechanically, or hydraulically configured to be placed at different locations with respect to one another on cylindrical peripheral conduit 403. Cylindrical peripheral conduit 403 may be constructed of high permeability magnetic material. Cylindrical peripheral conduit 403 also shows formed, wound cylindrical pressure controllers 410 and 420 wrapped with multiple layers of electrical conductors 411 and 421 and or super conductors, respectively. Formed, wound cylindrical pressure controllers 410 and 420 are juxtaposed adjacent to each other inside and outside, respectively, of cylindrical peripheral conduit 403 such that when simultaneously energized the electromagnetic flux 430 created by their north (N) poles is directed towards one another. Since wound cylindrical pressure controller 410 is formed with its leading (rightmost) surface at approximately a 45° angle with respect to the central axis of cylindrical peripheral conduit 403, wound cylindrical pressure controller 410, and wound cylindrical pressure controller 420, the combined electromagnetic flux 430 is directed rearward (to the right) of cylindrical peripheral conduit 403, wound cylindrical pressure controller 410, and wound cylindrical pressure controller 420. This creates a minute thrust of the entire assembly forward (to the left). The amount of thrust is proportional to the current applied to the electrical conductors 411 and 421 and or super conductors. The amount of thrust may also be controlled by changing the horizontal distance between cylindrical pressure controllers 410 and 420 on cylindrical inner cent conduit 403.

Referring now to FIG. 6b, the diagram shows a side cutaway view of an alternative embodiment of cylindrical peripheral conduit 403 with a single cylindrical formed, wound pressure controller 420 affixed. Cylindrical peripheral conduit 403 may be threaded on its inside and/or outside surfaces so that cylindrical pressure controller 420 may be placed at different locations with respect to cylindrical thrust vectoring unit 410 on cylindrical peripheral conduit 403. Alternately, cylindrical pressure controller 420 and cylindrical thrust vectoring unit 410 may be electrically, electromechanically, or hydraulically configured to be placed at different locations with respect to one another on cylindrical peripheral conduit 403. Cylindrical peripheral conduit 403 may be constructed of high permeability magnetic material. Cylindrical peripheral conduit 403 also shows formed, wound cylindrical pressure controller 420 wrapped with multiple layers of electrical conductors 421 and or super conductors. Formed, wound cylindrical pressure controller 420 and cylindrical thrust vectoring unit 410 are juxtaposed adjacent to each other inside and outside, respectively, of cylindrical peripheral conduit 403 such that when energized the electromagnetic flux 430 created by the north (N) poles of formed, wound cylindrical pressure controller 420 is directed towards cylindrical thrust vectoring unit 410. Since cylindrical thrust vectoring unit 410 is formed with its leading (rightmost) surface at approximately a 45° angle with respect to the central axis of cylindrical peripheral conduit 403, cylindrical thrust vectoring unit 410, and wound cylindrical pressure controller 420, the electromagnetic flux 430 is directed rearward (to the right) of cylindrical peripheral conduit 403, cylindrical thrust vectoring unit 410, and wound cylindrical pressure controller 420. This creates a minute thrust of the entire assembly forward (to the left). The amount of thrust is proportional to the current applied to the electrical conductors 421 and or super conductors. The amount of thrust may also be controlled by changing the horizontal distance between cylindrical pressure controllers 420 and cylindrical thrust vectoring unit 410 on cylindrical peripheral conduit 403.

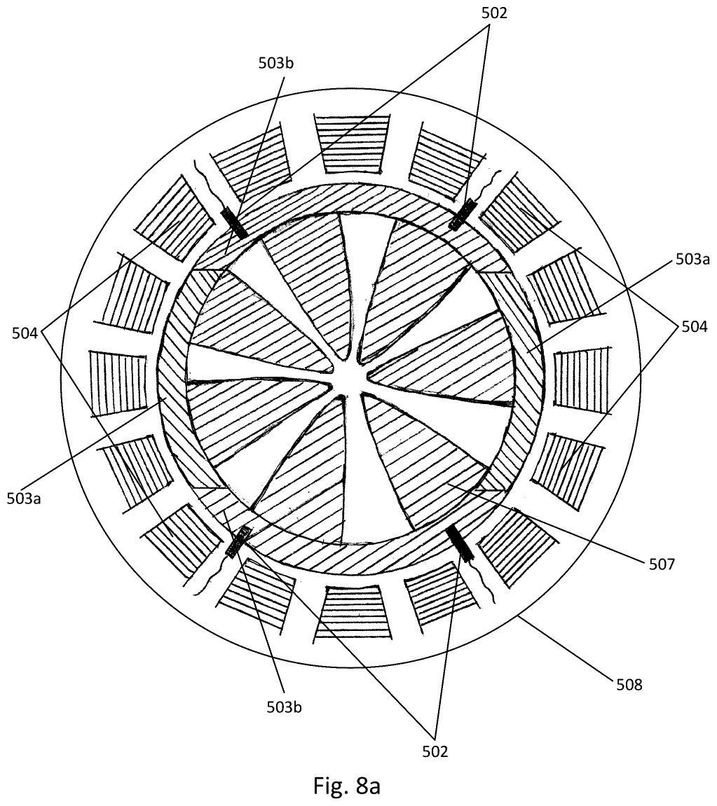

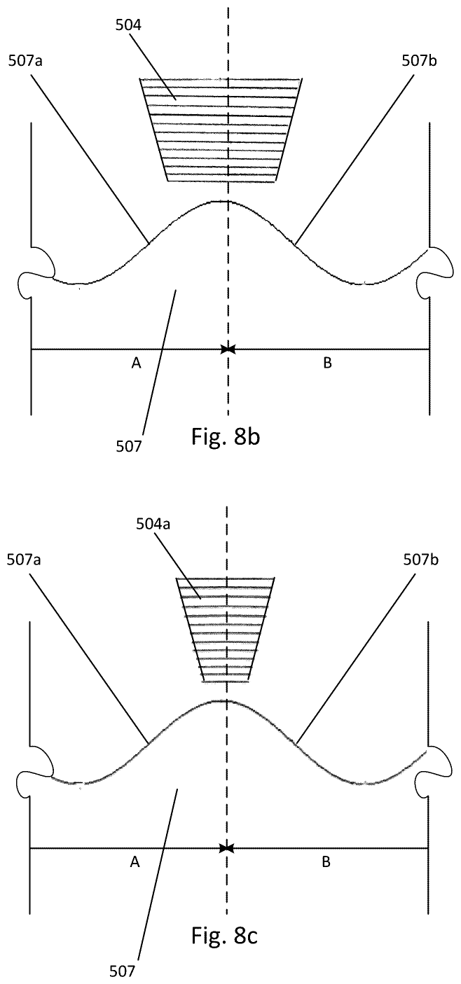

Referring now to FIGS. 7, 8a, 8b, and 8c a: 1) Longitudinal side cutaway view of a nacelle/pod 501 comprising a propulsion system further comprising a rim driven propeller/propulsor (RDP) unit 508 (FIG. 7); 2) A cross sectional view of a rim driven propeller/propulsor (RDP) unit 508 (FIG. 8a); and, 3) Details of the tip of a rotor 507 as it passes by a large stator element 504 and, in an alternative embodiment of the invention, a small stator element 504a, are shown (FIGS. 8b and 8c).

Nacelle/pod 501 is affixed to the end of mounting shaft 500 and is freely rotatable with respect to mounting shaft 500. An electronic controller controls the orientation of nacelle/pod 501 with respect to mounting shaft 500 and the direction of rotation of rotor 507 thus controlling the direction of the thrust of the propulsion system.

The RDP unit 508 is comprised of: 1) Rotor 507 constructed from, including but not limited to, electrically conductive or super conductive material; 2) Multiple electrically energized large stators 504 arranged circumferentially around rotor 507; 3) Stationary axial magnetic bearings 503, 503a, and 503b arranged laterally around the tips of the blades of rotor 507; and; 4) Position sensors 502. The multiplicity of large stators 504 operate on rotor 507 through magnetic induction. Said propulsion system is further comprised of coil windings 505 within nacelle/pod 501 and electric power coils 506. Those having skill in the art will recognize that coil windings 505 may be constructed in multiple layers.

The multiplicity of large stators 504 control the polar orientation of, and the intensity of, the electrical charge of rotor 507. The multiplicity of large stators 504 may be sequentially energized to cause rotor 507 to rotate either clockwise or counterclockwise producing a pulsating magnetic field with its flux polarity generally oriented in either longitudinal direction along the rotational axis of RDP unit 508. By this means the device may be made to accelerate in either direction along an existing magnetic field line.

The sloping surface of each blade of rotor 507 is designed to produce greater torque and increase the revolutions per minute of rotor 507 with less power when large stator element 504 is energized. When energized, the multiplicity of large stators 504 act as radial magnetic bearings to center rotor 507 during rotation and also electrically charge rotor 507. As rotation of the electrically charged rotor 507 increases, the blades of rotor 507 produce a varying wake in the generated magnetic flux, which when aligned along a selected magnetic field line, propel a craft through a vacuum along an existing magnetic field line.

To prevent or limit dispersion of said magnetic flux, coil windings 505 within nacelle/pod 501 may be energized to concentrate and channel flux through electric power coils 506 to produce electric power. Any power generated by electric power coils 506 may be reused to power the system. Those having skill in the art will recognize that coil windings 505 may have multiple layers. Also, nacelle/pod 501 may optionally be lined or layered with materials that deflect and channel the generated magnetic flux including, but not limited to, pyrolytic carbon/graphite. Stationary axial magnetic bearings 503, 503a and 503b located on both sides of rotor 507 laterally locate rotor 507 and prevent rotor 507 from contacting surfaces in RDP unit 508. Position sensors 502 monitor revolutions per minute, rotor charge, and rotor location and supply this data to an electronic controller.

Referring now specifically to FIG. 8b, a detail of the tip of a blade of rotor 507 as it passes by an individual large stator element 504 is shown. Large stator element 504 presents a less focused, less directed beam of electromagnetic energy to the lobes of rotor 507 as it passes by. When large stator 504 is energized on side A of lobe 507a it will force the rotor 507 to rotate in the direction shown by line A. When large stator 504 is energized on side B of lobe 507b it will force the rotor 507 to rotate in the direction shown by line B. The number of lobes 507a on the tip (or edge) of rotor 507 is at least one and may vary in shape and depth to maximize torque and minimize power input and overall efficiency. The number of large stators 504 is at least one but the height of large stators 504 is set to match the lobe heights of rotor 507 to energize large stators 504 at the proper time to rotate rotor 507 in the direction indicated by line A or line B. A number of equally spaced large stators 504 circumferentially placed around rotor 507 may be energized all, or part of, the time before and during operation of the rotor 507 to act as magnetic bearings to physically suspend the rotor 507 to prevent contact with the large stators 504 and other surfaces. As rotor 507 is energized by large stators 504 and begins rotation, rotor 507 generates power by magnetically inducing current in some fraction of large stators 504.

Referring now specifically to FIG. 8c, a detail of the tip of a blade of rotor 507 as it passes by an individual small stator element 504a is shown. Small stator element 504a presents a more focused, more directed beam of electromagnetic energy to the lobes of rotor 507 as it passes by. When small stator element 504a is energized on side A of lobe 507a it will force the rotor 507 to rotate in the direction shown by line A. When small stator element 504a is energized on side B of lobe 507b it will force rotor 507 to rotate in the direction shown by line B. The number of lobes 507a on the tip (or edge) of rotor 507 is at least one and may vary in shape and depth to maximize torque and minimize power input and overall efficiency. The number of small stators 504a is at least one but the height of small stators 504a is set to match the lobe heights of rotor 507 to energize small stators 504a at the proper time to rotate rotor 507 in the direction indicated by line A or line B. A number of equally spaced small stators 504a circumferentially placed around rotor 507 may be energized all, or part of, the time before and during operation of the rotor 507 to act as magnetic bearings to physically suspend the rotor 507 to prevent contact with the small stators 504a and other surfaces. As rotor 507 is energized by small stators 504a and begins rotation, rotor 507 generates power by magnetically inducing current in some fraction of small stators 504a.

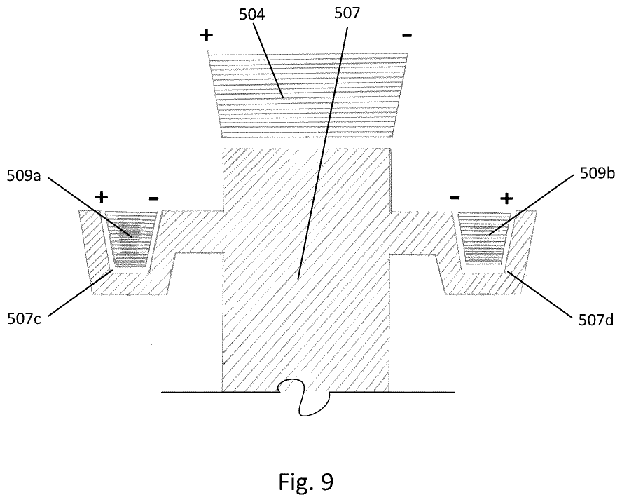

Referring now specifically to FIG. 9, a detail of an alternative embodiment of the outer periphery of rotor 507 as it passes an individual large stator element 504 is shown. In this embodiment, rotor 507 is supported and stabilized by two concentric guide channels 507c and 507d in which two peripheral electromagnetic guides 509a and 509b circumferentially run. Each peripheral electromagnetic guide 509a and 509b is circumferentially constructed in at least one segment wherein each segment is linearly constructed. The electromagnetic forces generated by the peripheral electromagnetic guides 509a and 509b act as a frictionless bearing surface which keeps rotor 507 isolated in space and act as a magnetic bearing to physically suspend the rotor 507 preventing contact with large stators 504, peripheral electromagnetic guides 509a and 509b, and other surfaces. The same kind of structure may be used with rotor 507 and small stators 504a.

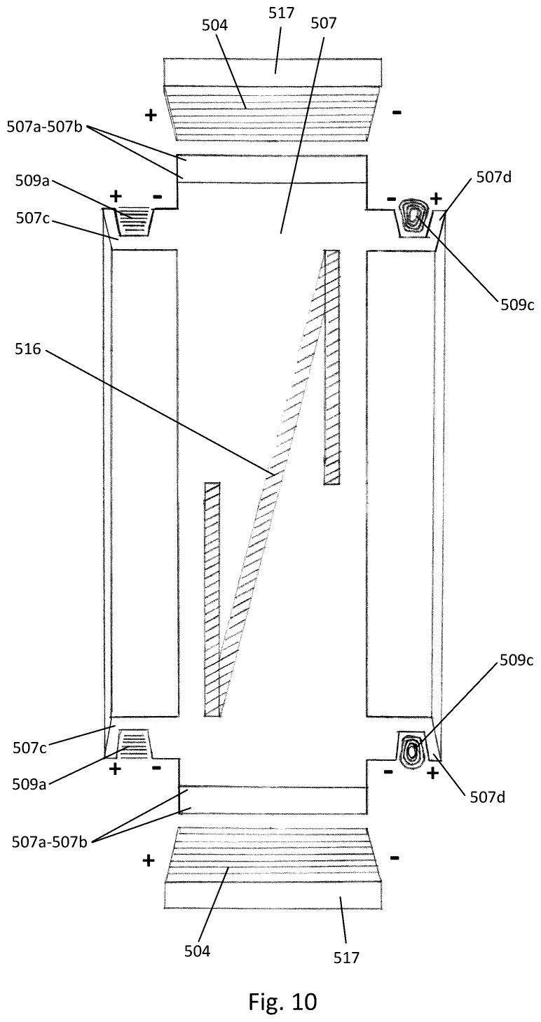

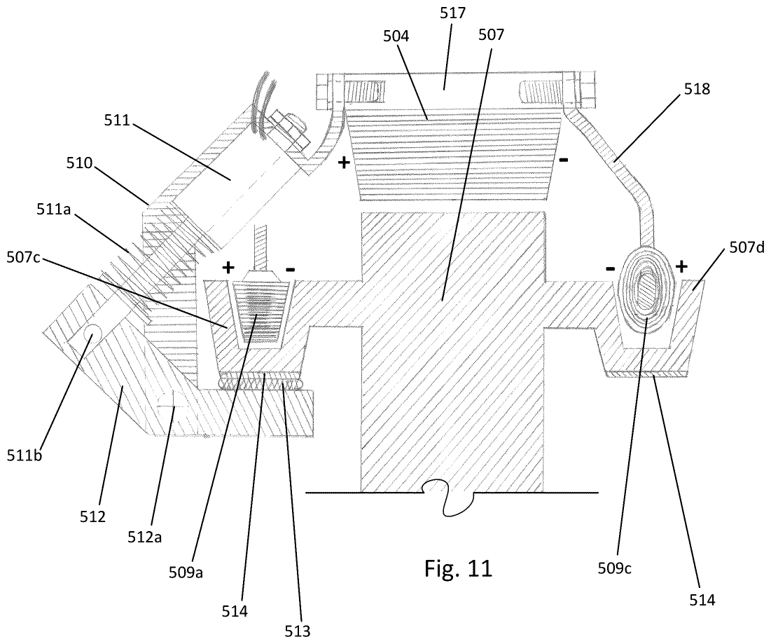

Referring now to FIGS. 8b, 8c, and 9 through 13 an alternative embodiment of rotor 507 as configured inside a circumferential ring of individual stators 504r comprising large stators 504 is shown. In this embodiment, rotor 507 is supported and stabilized by two concentric guide channels 507c and 507d in which two peripheral electromagnetic guides 509a and 509c circumferentially run. Each peripheral electromagnetic guide 509a and 509c is circumferentially constructed in at least one segment wherein each segment is linearly constructed (as shown in 509a) or circumferentially wound or rolled (as shown in 509c). The electromagnetic forces generated by the peripheral electromagnetic guides 509a and 509c act as a frictionless bearing surface which keeps rotor 507 isolated in space and act as a magnetic bearing to physically suspend the rotor 507 preventing contact with large stators 504, peripheral electromagnetic guides 509a and 509c, and other surfaces. The same structure may be constructed using small stators 504a. Affixed inside of rotor 507 is integral auger type blade 516. Integral auger type blade 516 rotates with rotor 507 and creates powerful wakes of linear wave magnetic flux as rotor 507 is electrically charged and rotates at high speed. This linear wave of magnetic flux efficiently propels a spacecraft through space.

Rotor 507 may be constructed of lightweight electrically conductive materials able to hold a high electric charge including, but not limited to, aluminum, steel, and magnesium. Rotor 507 is designed to operate in harsh environments (such as the vacuum of space) where minimal positively charged hydrogen and helium ions and negatively charged electrons exist and electric arcing may be minimized when rotor 507 is electrically charged. Optionally rotor 507 may be lined and/or enameled and/or varnished with thin layers of electrical insulating materials including, but not limited to: polymers, polymeric plastic, resins, rubbers, plastics, polyvinylchloride, pure cellulose paper, glass, and so on, to further prevent electric arcing when rotor 507 is electrically charged.

Rotor 507 is supported and stabilized by two concentric guide channels 507c and 507d in which two peripheral electromagnetic guides 509a and 509c circumferentially run. Each peripheral electromagnetic guide 509a and 509c is circumferentially constructed in at least one segment wherein each segment is linearly constructed (as shown in 509a or 509b) or circumferentially wound or rolled (as shown in 509c). The electromagnetic forces generated by the peripheral electromagnetic guides 509a or 509b and 509c act as a frictionless bearing surface which keeps rotor 507 isolated in space and act as a magnetic bearing to physically suspend the rotor 507 preventing contact with large stators 504, peripheral electromagnetic guides 509a or 509b and 509c, and other surfaces. The same kind of structure may be used with small stators 504a.

An alternative embodiment of main engine ring 517 has at least one friction braking and support assembly comprising braking system support bracket 510, solenoid 511, brake assembly retracting spring 511a, brake arm actuator pin 511b, brake arm 512, brake arm pivot pin 512a, brake pad 513, and brake liner 514 are shown. Those having skill in the art will recognize that brake pad 513 and brake liner 514 may be constructed of various materials including, but not limited to, nylon, composite, and ceramic materials. Also, those having skill in the art will recognize that brake pad 513 and brake liner 514 may be associated with a heat dissipating radiator. Also, those having skill in the art will recognize that usually at least two braking and support assemblies are provided and that when more than one braking and support assemblies are provided that they are spaced equally along the shown circle of main engine ring 517. Also, those having skill in the art will recognize that an electromagnetic induction braking system may also, or, alternately be included. Also, those having skill in the art will recognize that braking and support assemblies may be affixed to both the left and right sides of main engine ring 517.

The braking and support system shown is activated when an electrical current is provided to solenoid 511 which presses out against brake assembly retracting spring 511a, into brake arm actuator pin 511b, pivoting brake arm 512 around brake arm pivot pin 512a, forcing brake pad 513 to ride against brake liner 514. This slows and stops the rotation of rotor 507 and supports rotor 507 so that it does not contact other surfaces. Those having skill in the art will recognize that many other types of braking systems may be used including disc braking systems and friction braking systems impinging on other parts of rotor 507 or working by means of electromagnetically inducing current in stator(s) included in the circumferential ring of individual stators 504r.

Inside the circumference of main engine ring 517 is the circumferential ring of individual stators 504r. Those having skill in the art will recognize that different sizes and shapes of stators including large stators 504 and small stators 504a may comprise the circumferential ring of individual stators 504r. Radially inside main engine ring 517 and the circumferential ring of individual stators 504r is at least one peripheral electromagnetic guide (509a, or 509b, or 509c).

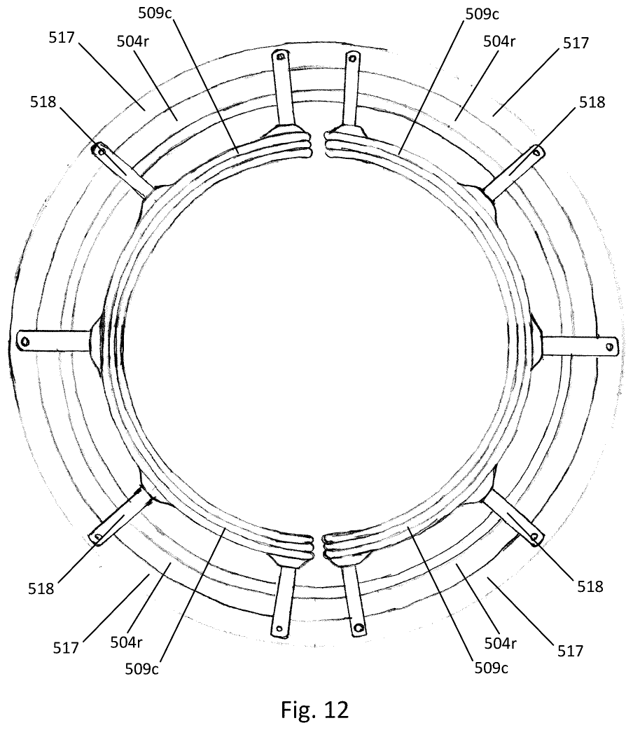

Referring now specifically to FIG. 12, two peripheral electromagnetic guides 509c are shown each comprising approximately half of the circumferential length of the shown circle. Peripheral electromagnetic guides 509c are affixed to main engine ring 517 by support arms 518.

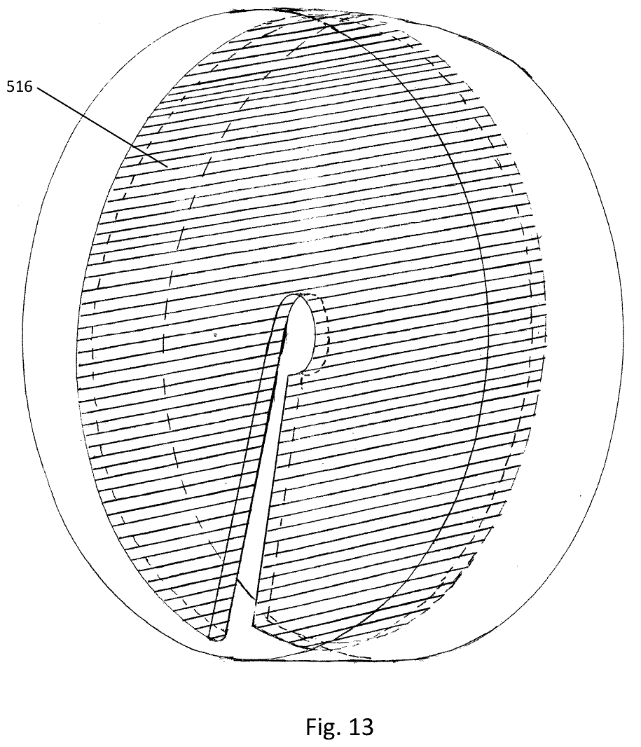

Referring now to FIG. 13, the shape of an integral auger type blade 516 is shown as it lies inside a rotor. Integral auger type blade 516 is spiral in shape and may have any spiral height. Integral auger type blade 516 may have a fixed, or, varying spiral height. Those having skill in the art will recognize that auger type blade 516 may have more than one rotation and there may be more than one auger type blade 516 aligned along the rotational axis of the rotor.

An electronic controller will monitor and control all processes and operations of said magnetic flux drive. The electronic controller controls the application of electrical current to all of the components of the magnetic flux drive including the: 1) Peripheral electromagnetic guides (509a, or 509b, or 509c); 2) Large stators 504 or the small stators 504a; and, 3) Concentric guide channels 507c and 507d. Attaching and or mounting the magnetic flux drive to the main body or fuselage of a craft on both sides, fore and aft, may afford attitude and/or directional control of the craft.

It is to be understood that the present invention is not limited to the illustrations and details shown. Those skilled in the art may modify elements and aspects described but may not deviate from the spirit and scope of the claims. For example, those having skill in the art will recognize that the direction of thrust of the elements disclosed and shown in FIGS. 4b, 5, 6a, 6b, 9, 10, and 11 may be essentially reversed by changing the polarity of the electrical circuit energizing: 1) The electrical conductors and/or super conductors 211, 311, 411, 221, 321, and 421; 2) The large and small stators 504 and 504a; and, 3) The peripheral electromagnetic guides 509a, 509b, and 509c.

Also, those having skill in the art will recognize that some of the magnetic flux 230, 330, and 430 disclosed and shown in FIGS. 4b, 5, 6a, and 6b may interact with electric power coils to generate electric power. In the embodiment of the invention shown in FIGS. 7, 8a, 8b, 8c, 9, 10, and 11 electric power may be generated when electric power coils 506 are affixed and are exposed to the magnetic flux generated by rotor 507 when it rotates.

Also, it will be obvious to those having skill in the art that electric power to energize the devices disclosed may be provided by numerous electrical power sources, including, but not limited to, solar panels, nuclear reactors, fusion reactors, and electric power may be stored in batteries. Further, FIGS. 1, 2, 4b, 5, 6a, 6b, 9, 10, and 11 indicate the electrical polarity of the current to be applied from the chosen electrical source to the disclosed embodiment of the invention. This indication is made by means of “+” and “−” annotations on the drawings. Further, the direction of thrust generated by the engine may be reversed by reversing the polarity of the electrical current supplied to the RDP. Finally, the disclosed invention is primarily designed to function in the environment of space for spacecraft propulsion systems that require only electric power.

Also, those having skill in the art will recognize that outer space (or simply space) is the expanse beyond celestial bodies and their atmospheres. Outer space is not completely empty; it is a near perfect vacuum containing a low density of particles, predominantly a plasma of positively charged hydrogen and helium ions and negatively charged electrons.

A stream of electrons or ions may be used to create thrust when directed along the magnetic field lines of the magnetic flux drive. One having skill in the art will recognize that electrons or ions may be captured according to electrical charge relative to the input of the magnetic flux drive and those electrons or ions are directed linearly along the magnetic field lines through the output of the magnetic flux drive, thus creating a thrust directed towards the input of the magnetic flux drive.

What is claimed:

1. An electromagnetic flux engine for spacecraft propulsion comprised of:
a) a hollow central conduit;
b) a first electromagnetic coil wherein said first electromagnetic coil is wound around the hollow central conduit;
c) at least one second electromagnetic coil wherein said second electromagnetic coil is wound inside a first, formed, wound pressure controller located inside said hollow central conduit wherein the axis of the first, formed, wound pressure controller is aligned along the axis of the central conduit;
d) a variable exhaust nozzle or a cone shaped electrical coil;
e) wherein electromagnetic flux may be accelerated through said hollow central conduit by energizing the first electromagnetic coil by means of an electrical source to direct magnetic flux through the variable exhaust nozzle or cone shaped electrical coil around the first, formed, wound pressure controller; and
f) wherein the variable exhaust nozzle or cone shaped electrical coil deflects and/or concentrates magnetic flux, which, depending on the polarity of electrical charge imparted to the first, formed, wound pressure controller causes negatively charged electrons or positively charged hydrogen or helium ions to be accelerated along the lines of magnetic flux to produce thrust.

2. An electromagnetic flux engine for spacecraft propulsion of claim 1 further comprising an exterior layer capable of withstanding magnetic flux.

3. An electromagnetic flux engine for spacecraft propulsion of claim 1 wherein the hollow central conduit is constructed of a solid iron-based composite tubular nanocrystalline foil.

4. An electromagnetic flux engine for spacecraft propulsion of claim 1 wherein said first, formed, wound pressure controller may be constructed of non-ferrous magnetic material.

5. An electromagnetic flux engine for spacecraft propulsion of claim 1 wherein the electromagnetic magnetic flux engine is comprised of a plurality of venturi.

6. An electromagnetic flux engine for spacecraft propulsion of claim 1 wherein the electromagnetic magnetic flux engine is further comprised of a plurality of accelerating coils to amplify high velocity magnetic flux through venturi and variable exhaust nozzle or cone shaped electrical coil.

7. An electromagnetic flux engine for spacecraft propulsion of claim 1 wherein said variable exhaust nozzle or cone shaped electrical coil is constructed of non-ferrous magnetic material.

8. An electromagnetic flux engine for spacecraft propulsion of claim 1 wherein the magnetic flux engine is further comprised of electric power coils aligned within the concentrated magnetic flux to generate electric power.

9. An electromagnetic flux engine for spacecraft propulsion of claim 1 wherein the magnetic flux engine is initially powered by solar power panels.

10. An electromagnetic flux engine for spacecraft propulsion of claim 1 wherein the magnetic flux engine is initially powered by a nuclear reactor.

11. An electromagnetic flux engine for spacecraft propulsion of claim 1 wherein a second, formed, wound, pressure controller is located inside said hollow central conduit wherein the axis of the second, formed, wound pressure controller is aligned along the axis of the central conduit.

12. An electromagnetic flux engine for spacecraft propulsion of claim 1 wherein said second, formed, wound, pressure controller is aligned such that its polarity, when charged, is opposite the polarity present on the first, formed, wound pressure controller aligned along the axis of the central conduit.

13. An electromagnetic flux engine for spacecraft propulsion of claim 1 wherein said second, formed, wound, pressure controller is aligned such that its polarity, when charged, is opposite the polarity present on the first, formed, wound pressure controller aligned along the axis of the central conduit, and that the electromagnetic field generated by said second, formed, wound, pressure controller counteracts, or modulates, the electromagnetic field generated by said first, formed, wound, pressure controller.
